(19) United States
(12) Patent Application Publication
(10) Pub. No.: US 2005/0166213 A1
(43) Pub. Date: Jul. 28, 2005

(54) Remote deployment of executable code in a pre-boot environment

(75) Inventors: Daryl Carvis Cromer, Apex, NC (US); Joseph Wayne Freeman, Raleigh, NC (US); Steven Dale Goodman, Raleigh, NC (US); Randall Scott Springfield, Chapel Hill, NC (US)

Correspondence Address: IBM COPORATION (RTP);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/749,584

(22) Filed: Dec. 31, 2003

(51) Int. Cl. G06F 3/00

(52) U.S. Cl. 719/315

(57) ABSTRACT

Methods, systems, and media are disclosed for managing a remote client of a computer system. One example embodiment includes transmitting a modified wake-on LAN (“WOL”) packet to a network receive buffer on the remote client, wherein the modified WOL packet comprises additional data, such as executable code or functions. Further, the example embodiment includes retrieving, by BIOS associated with the remote client, of the modified WOL packet from the network receive buffer, storing, by the BIOS, storing of the additional data in memory associated with the network receive buffer, and retrieving, by BIOS associated with the remote client, of the additional data from the memory. Further still, the example embodiment includes processing of the additional data, which may occur by an application stored on the PARTIES partition, wherein the parsed, additional data is interpreted and executed by the application.

### FIELD OF INVENTION

The invention is in the field of data processing systems and, in particular, a data processing systems, methods, and media for remote wake-up and management of systems on a network. More particularly, the invention relates to systems, methods, and media for managing a remote client by deploying executable code in a modified wake-on-LAN (wherein “LAN” is an abbreviation for “local area network”) packet, wherein BIOS retrieves and loads the executable code either directly from memory associated with a network receive buffer or, through use of an application, from a protected area run time interface extension services (“PARTIES”) space of a hard drive associated with the remote client.

### BACKGROUND

Personal computer systems are well known in the art, and their widespread use provide computer power to many segments of today's modern society. Personal computers (PCs) are definable as a desktop, floor standing, or portable microcomputer that generally include a system unit having a central processing unit (“CPU”) and associated volatile and non-volatile memory, including random access memory (“RAM”) and basic input/output system read only memory (“BIOS ROM”), a system monitor, a keyboard, one or more flexible diskette drives, a CD-ROM drive, a fixed disk storage drive (also known as a “hard drive”), a pointing device such as a mouse, and an optional network interface adapter. One of the distinguishing characteristics of such a system is the use of a motherboard or system planar to electrically connect these components together. Examples of such personal computer systems are IBM's PC 300® series, Aptivae series and Intellistation® series.

Connecting PCs via networks allows increased computing power, storage, and data transfer by pooling the resources associated with the individual clients of the greater computer system. Despite the obvious advantages of networked computer systems, however, management, such as maintenance, updating and repair, of a client on the network may be troublesome because the client may be in a remote location to the system troubleshooter, such as a system administrator, operator, configurator, or manager.

In today's computer environment, remote management is essential in order to reduce maintenance costs. Otherwise, a system troubleshooter must travel or be local to the client to be managed—a cost-prohibitive solution for an organization having many dispersed clients. As a result, system management is typically performed in a central location for remote management of the clients.

Despite the existence of remote management, most of the time, system management tools run on applications loaded on the computer system, and, therefore, require the primary operating system (“OS”) to be loaded and functioning. However, when the OS does not load, for whatever reason, a system troubleshooter is unable to remotely manage or repair a client.

Prior solutions for managing a client without the OS running typically perform a pre-execution environment (“PXE”) boot to a server of the computer system, and then download a client image to boot. This is problematic, however, because a rogue server could easily hijack the client, and, therefore, compromise the computer system's integrity, that is, security. Providing a verification means for the server has also proven problematic to cure this rogue server/security situation because the amount of BIOS code necessary to validate the server typically breaks the BIOS flash ROM size. Therefore, remote management of a client by a PXE boot leaves the possibility of secure management, such as repair and updating of the client, unanswered.

In addition to known solutions for remotely managing clients in a pre-boot environment, it is noteworthy to further discuss known methods for “waking up” clients desired to be managed. That is, oftentimes, in a pre-boot environment, a client to be managed may be asleep or powered-off. One known method for waking or powering up such a client is through use of “wake-on-LAN” technology. This method permits a remote client, or associated part thereof, on the network to power-up by transmitting a wake-on-LAN packet having the appropriate information. A commonly known wake-on-LAN technology for achieving the remote wake-up of a client is through use of AMD's Magic-Packet®. Even after waking up the client desired to be managed, however, the problem of the above-discussed prior solutions remains. That is, remote management of a client by a PXE boot is not secure.

A need, therefore, exists, for methods, systems, and media for managing a remote client on a computer system in a secure manner, and especially so if the operating system is not loaded or functioning.

### SUMMARY OF THE INVENTION

Embodiments of the invention generally provide methods, systems, and media for managing a remote client of a computer system. In one embodiment, the method generally includes receiving a modified wake-on-LAN packet to a network receive buffer on the remote client, wherein the modified wake-on-LAN packet comprises executable code or functions. Further, the method includes storing of the executable code or functions in memory associated with the network receive buffer, and retrieving, by BIOS associated with the remote client, of the executable code or functions from the memory. Further still, the method includes processing, by the BIOS, of the executable code or functions.

Another embodiment involves a service for managing a remote client of a computer system. The service generally includes adding executable code to a wake-on-LAN packet to yield the modified wake-on-LAN packet, wherein the executable code is designed for storage in a network receive buffer and processing by BIOS associated with the remote client; and transmitting the modified wake-on-LAN packet to the remote client via a network in communication with the remote client and a computer associated with the computer system.

A further embodiment provides a system for managing a remote client of a computer system. The system generally includes a network in communication with the remote client and a computer associated with the computer system, and a network receive buffer on the remote client for receiving a modified wake-on-LAN packet, wherein the modified wake-on-LAN packet comprises executable code or functions. Further, the system includes memory coupled to a processor of the remote client, wherein the memory comprises a first instruction for BIOS associated with the remote client to store the executable code or functions in the memory, a second instruction to retrieve the executable code or functions from the memory, and a third instruction to process the executable code or functions.

Yet another embodiment provides a machine-accessible medium containing instructions, which when executed by a machine, causes the machine to perform operations for managing a remote client of a computer system. The instructions generally include operations for receiving a modified wake-on-LAN packet via a network receive buffer on the remote client, wherein the modified wake-on-LAN packet comprises executable code or functions. Further, the instructions include operations for storing of the executable code or functions in memory associated with the network receive buffer, and instructions for retrieving, by BIOS associated with the remote client, of the executable code or functions from the memory. Further still, the instructions include operations for processing, by the BIOS, of the executable code or functions.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts an environment for a system for remote wake-up and management of a client computer by a computer according to one embodiment.

FIG. 2 depicts an exploded perspective view of certain elements of a personal computer according to one embodiment, including a chassis, a cover, and a planar board.

FIG. 3 depicts a block diagram of certain components of the personal computer of FIG. 2.

FIG. 4 depicts a diagrammatic representation of a network packet which is sent by a personal computer according to one embodiment.

FIG. 5 depicts a diagrammatic representation of a network packet which is sent by a personal computer according to one embodiment.

FIG. 6 depicts an example embodiment of a system for managing a remote client of a computer system in accordance with the disclosed invention.

FIG. 7 depicts a flowchart managing a remote client of a computer system in accordance with the disclosed invention.

### DETAILED DESCRIPTION OF EXAMPLE EMBODIMENTS

The following is a detailed description of example embodiments of the invention depicted in the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, systems, methods, and media for managing a remote client of a computer system are contemplated. Embodiments include a computer system having a computer in connection with the remote client over a network. The remote client has the capability of accepting and understanding wake-on-LAN (“WOL”) packets, such as AMD's Magic Packets, which serve to wake an otherwise powered-off, remote client seeking to be managed by a system administrator or similarly empowered network authority (“troubleshooter”). Before a troubleshooter transmits an ordinary WOL to the remote client, software and/or hardware associated with the troubleshooter's computer permits modification of the ordinary WOL by the addition of data, such as executable code, functions, or any other desired addition to the payload portion of the ordinary WOL packet(s) for ultimate deployment in managing of the remote client. The additional data in the payload of the ordinary WOL results in the formation of what is termed a “modified wake-on-LAN” or “modified WOL” packet(s). The troubleshooter transmits, via the network, the modified WOL to a network receive buffer, such as one on a network interface card (“NIC”) having WOL support capabilities, associated with the remote client. Before the remote client may utilize the modified WOL, however, the troubleshooter should modify the BIOS with instructions or engage BIOS settings enabled by software and/or hardware associated with the computer system. These instructions direct the BIOS how to behave in response to the modified WOL packets, which contain the additional data, once the modified WOL packets are received by the network receive buffer. In one instance, the instructions inform the BIOS to store the executable code or functions, such as a ROM BIOS extension, in memory associated with the network receive buffer, then to retrieve the executable code or functions in memory associated with the network receive buffer, and then to process the executable code after optional validation of the retrieved, executable code or functions. In another instance, the instructions inform the BIOS to retrieve the modified WOL packets from the network receive buffer, store the additional data within the modified WOL packets to a protection area run time interface extension services (“PARTIES”) space on the hard drive, wherein the PARTIES space, in layman's parlance, is a hidden area, outside of the purview of the operating system associated with the computer system. Before storing the additional data, however, further instructions may have the BIOS query the integrity of the received modified WOL to ensure security of the computer system is not compromised in any manner. Such verification query instructions may include the use of a private/public key algorithm associated with the modified WOL and the computer system. Presuming execution of optional verification instructions confirm the integrity of the modified WOL, then after storing the additional data to the PARTIES, further instructions provided through software and/or hardware to the BIOS direct the BIOS to boot from the PARTIES. With all of the aforementioned occurring without the running or functioning of the operating system associated with the computer system, a preloaded application on the PARTIES partition accesses the additional data after the booting, and parses the additional data, wherein the application then interprets and executes the application, and thereby, uses the additional data in order to manage the remote client. As a result, the underlying additional data deployed in the payload to produce the transmitted, modified WOL performs the management function desired by the troubleshooter.

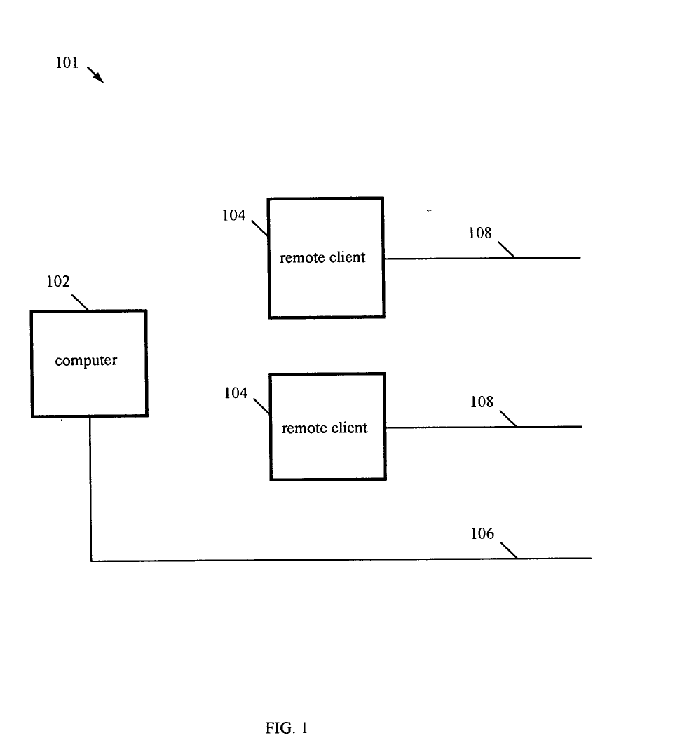

Turning now to the drawings, FIG. 1 depicts one embodiment of a data processing system 101 for providing wake-up and management of client computers according to one embodiment. System 101 includes a computer 102 (“computer”) coupled to one or more remote clients, wherein one is termed a “remote client” 104, within an overall computer system 106. The remote client 104 may be equipped with WOL capability, which provides them with the ability to be “asleep” in a low-power state while also providing the ability to be “woken up”, or returned to a full power state, when a WOL-equipped NIC receives the appropriate WOL command. WOL is also sometimes known as remote wake-up or Magic Packet technology. In system 101, the computer 102 and remote client 104 may be located at the same location, such as in the same building or computer lab, or could be geographically separated. While the term “remote” is used with reference to the distance between the computer 102 and remote client 104, the term is used in the sense of indicating separation of some sort, rather than in the sense of indicating a large physical distance between the systems. In fact, the computer 102 and remote client 104 may be physically adjacent in some network arrangements.

In one embodiment, remote client 102 is connected to a hub (not shown) utilizing a local area network (LAN) connector bus 106. In this embodiment, one or more clients 104 also connect to the hub through respective LAN busses 108. One form of the network conforms to the Ethernet specification and uses such hubs. It will be appreciated, however, that other forms of networks, such as token ring, may be utilized to implement the invention.

The computer 102 and one or more remote clients 104 are therefore associated one with the other through some form of LAN or the like, in which effective communication may be established through electrically conductive connections, through fiber optical links, through infrared or other radiation links, or in other manners. A “network” may include any type of data communications channel, such as an Ethernet network, token ring, X.10, X.25, etc. Those skilled in the art will recognize that the invention described herein may be implemented utilizing any type of data communications channel.

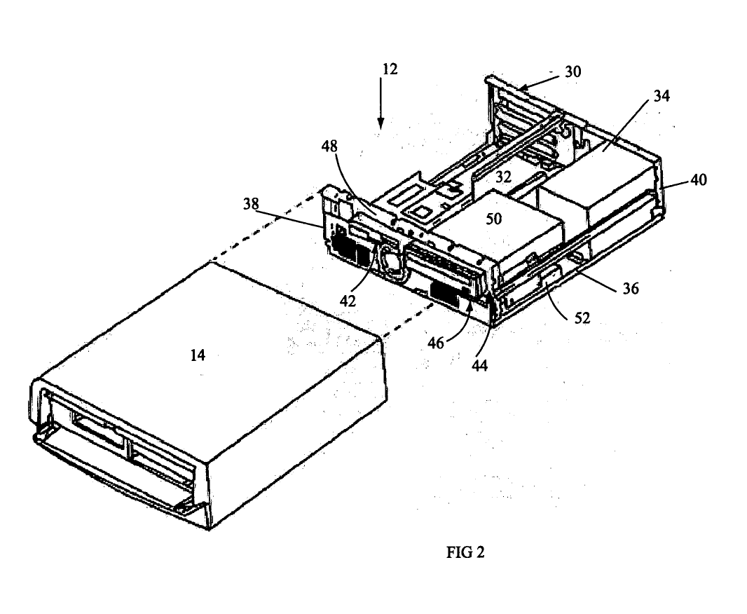

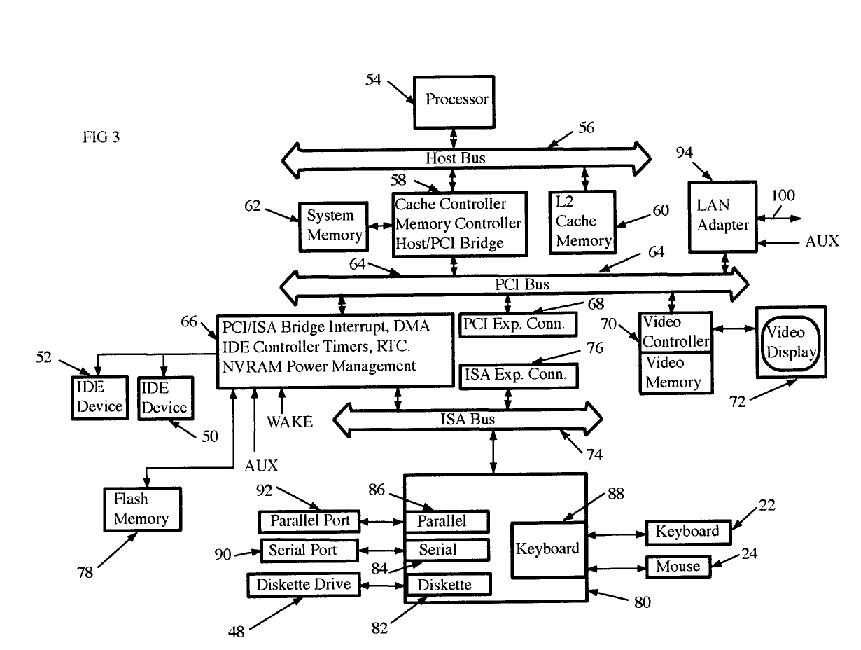

FIGS. 2 and 3 depict one embodiment of a personal computer 12 suitable for use as, for example, a remote client 104. In one embodiment, computer 102 may also be a personal computer 12. Alternatively, the computer 102 may be some computer having capabilities other than those ascribed herein to a “personal computer”, and possibly beyond those capabilities.

As shown in FIG. 2, personal computer 12 comprises a cover 14 which is a decorative outer member which cooperates with a chassis 30 in defining an enclosed, shielded volume for receiving electrically powered data processing and storage components for processing and storing digital data. At least certain of these components are mounted on a multi-layer planar 32 or motherboard which is mounted on the chassis 30 and provides a means for electrically interconnecting the components of the personal computer 12 including those identified above and such other associated elements as floppy disk drives, various forms of direct access storage devices, accessory adapter cards or boards, and the like. As pointed out more fully hereinafter, provisions are made in the planar 32 for the passage of input/output signals to and from the operating components of the personal computer 12.

Personal computer 12 has a power supply 34, which may be actuated by a power switch (not shown). The chassis 30 has a base indicated at 36, a front panel indicated at 38, and a rear panel indicated at 40. The front panel 38 defines at least one open bay for receiving a data storage device such as a disk drive for magnetic or optical disks, a tape backup drive, or the like. In the illustrated form, a pair of upper bays 42, 44 and a lower bay 46 are provided. One of the upper bays 42 is adapted to receive peripheral drives of a first size (such as those known as 3.5 inch drives) while the other 44 is adapted to receive drives of a different size (such as a CD-ROM or DVD-ROM drive) and the lower bay is adapted to receive another drive. One floppy disk drive indicated at 48 is a removable medium direct access storage device (DASD) capable of receiving a diskette inserted there into and using the diskette to receive, store and deliver data as is generally known. One CD-ROM drive indicated at 50 is a removable medium DASD capable of receiving a compact disc inserted there into and using the disc to deliver data as is generally known. One hard disk drive is indicated at 52 and is a fixed medium DASD capable of storing and delivering data as is generally known.

Referring now to FIG. 3, there is shown a block diagram of a client computer system illustrating the various components of the personal computer of FIG. 2. The components of FIG. 3 comprise components mounted on the planar 32 or other hardware of the personal computer 12. Connected to the planar 32 is the system CPU or processor 54 which is connected directly to a high speed host bus 56. A first system core logic chipset 58 and L2 cache memory 60 are also connected to the host bus 56. The first core logic chipset 58 includes a memory control unit, a L2 cache controller and a peripheral component interconnect (PCI) bridge. The memory control unit is further connected to a volatile random access memory (RAM) 62. The RAM memory 62 is composed of one or more memory modules. The memory control unit, or memory controller, includes the logic for mapping addresses to and from the microprocessor 54 to particular areas of RAM 62. The cache controller is operatively coupled to the L2 cache memory 60.

The first core chipset 58 can be, for example, a Triton VX chip which is sold by Intel Corporation. The PCI bridge within chipset 58 provides an interface between the host bus 56 and a PCI bus 64. Connected to the PCI bus 64 is a second core chipset 66 and a plurality of PCI expansion connectors 68 for receiving PCI bus compatible peripheral cards. One such peripheral card is a video controller 70. The video controller 70 includes video memory and is coupled to the monitor or video display terminal 72. The chipset 66 can be, for example, a PIIX4 chip which is also sold by Intel Corporation.

The chipset 66 contains a bus control and timing unit, a plurality of timers, an interrupt controller, a direct memory access (DMA) unit, nonvolatile CMOS RAM (also herein referred to as NVRAM), a CMOS real-time clock (RTC), Flash memory interface, a PCIIISA bridge, an integrated drive electronics (WDE) controller, and power management circuitry. The PCI/ISA bridge provides an interface between the PCI bus 64 and an optional feature or expansion bus such as the Industry Standard Architecture (ISA) bus 74. Connected to the ISA bus 74 are a plurality of ISA expansion connectors 76 for receiving ISA adapter cards (not shown). ISA adapter cards can be pluggably connected to the ISA expansion connectors 76 and may provide additional devices or memory for the personal computer 12.

Attached to the chipset 66 is a flash memory (FM) module or chip 78. Flash memory module 78 contains microcode that personal computer 12 will execute on power on and comprises. The flash memory 78 is an electrically erasable programmable read only memory (EEPROM) module or chip. The IDE controller provides for the attachment of IDE compatible storage devices such as the fixed disk drive 52 and CD-ROM drive 50.

The real-time clock is used for time of day calculations and the NVRAM is used to store system configuration data. That is, the NVRAM will contain values which describe the present configuration of the personal computer 12. For example, NVRAM 66 contains information describing the type of fixed disk or diskette, the list of IPL devices set by a user and the sequence to be used for a particular power on method, the type of display, the amount of memory, time, date, etc. Furthermore, these data are stored in NVRAM whenever a special configuration program, such as configuration/setup, is executed. The purpose of the configuration/setup program is to store values characterizing the configuration of the system to NVRAM.

Power management logic within chipset 66 is for changing the personal computer 12 between various power states (e.g., off, suspend and normal operating states). The circuitry is supplied with auxiliary power (AUX) from the power supply 34 (as shown in FIG. 2) when the personal computer 12 is in the off state so that it can monitor events which cause the personal computer 12 to turn on. For example, the circuitry 66 also includes a timer which is configurable by a user to expire after a predetermined period of time. When the timer expires, the circuitry 66 will cause the personal computer 12 to change from the off state to the normal operating state.

Coupled to the ISA bus 74 is a multi-function I/O controller 80 such as, for example, a National Semiconductor PC87307. The I/O controller 80 contains a variety of I/O adapters and other components such as the diskette adapter 82, serial adapter 84, a parallel adapter 86 and keyboard controller 88. The diskette adapter 82 provides the interface to the diskette drive 48. The serial adapter 84 has an external port connector 90 for attachment of external devices such as modems (not shown). The parallel adapter 86 has an external port connector 92 for attachment of external devices such as printers (not shown). The keyboard controller 88 is the interface for the keyboard connector 22 and the mouse connector 24.

A communication subsystem 94 can be coupled to either the PCI bus 64 or ISA bus 74 for allowing personal computer 12 to communicate (i.e., transmit/receive data) with a remote computer or server over a LAN via a connection or link 100. The communication subsystem 94 can be, for example, a LAN adapter or a LAN connection embedded on the planar 32. Communication subsystem 94 may also be known as a network interface card (NIC). Communication subsystem 94 may include a Media Access Controller (MAC), which serves as an interface between a shared data path (e.g., a media independent interface as described below) and the PCI bus 64 (or ISA bus 74 if communication subsystem 94 were connected to the ISA bus 74). The MAC performs a number of functions involved in the transmission and reception of data packets. For example, during the transmission of data, the MAC assembles the data to be transmitted into a packet with address and error detection fields. Conversely, during the reception of a packet, the MAC disassembles the packet and performs address checking and error detection. In addition, the MAC typically performs encoding/decoding of digital signals transmitted over the shared path and performs preamble generation/removal as well as bit transmission/reception. The MAC can be, for example, an Intel 82557 chip.

The communication subsystem 94 further comprises a physical layer and a media independent interface (MIU), which is a local bus between the MAC and the physical layer. The MII is a specification of signals and protocols which formalizes the interfacing of a 10/100 Mbps Ethernet MAC, for example, to the underlying physical layer. The physical layer receives parallel data from the MII local bus and converts it to serial data for transmission over cable 100. The physical layer may be, for example, an Integrated Circuits Systems 1890 chip. The physical layer includes auto-negotiation logic that, in one embodiment, determines the capabilities of the computer 102, advertises its own capabilities to the computer 102, and establishes a connection with the computer 102 using the highest performance common connection technology.

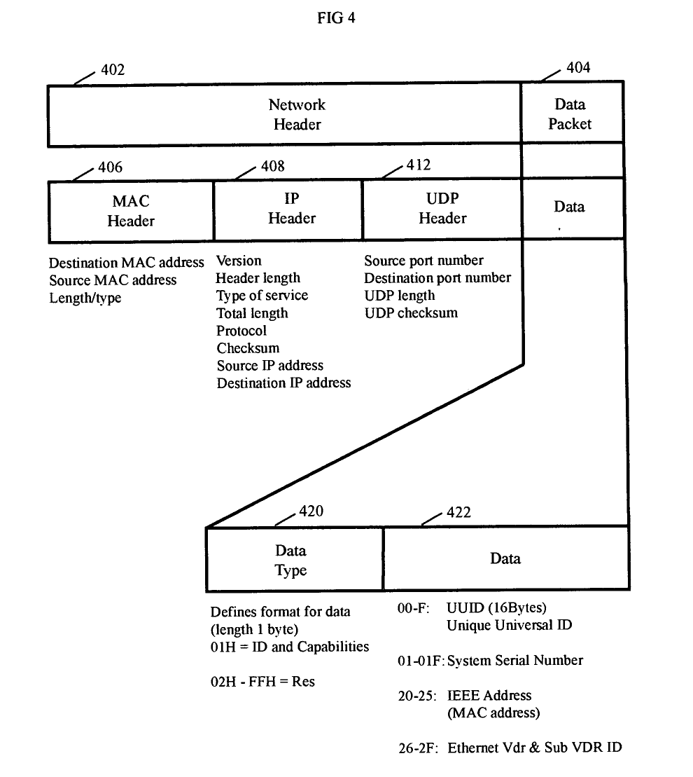

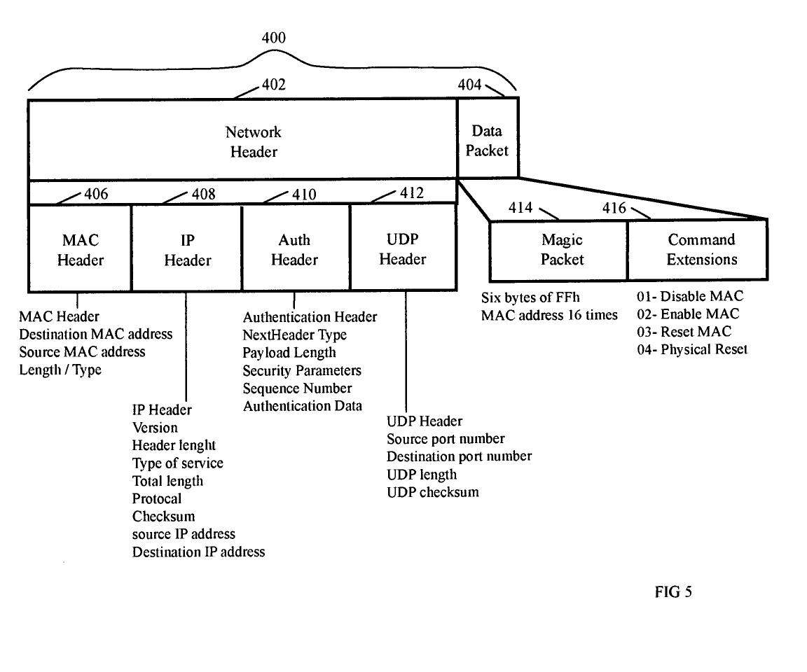

When the communication subsystem 94 is in WOL mode (e.g., when the client 104 is asleep), communication subsystem 94 scans all incoming frames addressed to client 104 for a specific data sequence which indicates that the frame is a WOL or Magic Packet frame. WOL packets and frames are described in more detail in relation to FIGS. 4 and 5. If the communication subsystem 94 scans a frame and does not find the appropriate WOL sequence, it discards the frame and takes no further action. If it detects the WOL sequence, however, it then alerts the power management circuitry 66 to wake up or power on the system.

While the invention is described hereinafter with particular reference to the system block diagram of FIG. 3, it is to be understood at the outset of the description which follows that it is contemplated that the apparatus and methods in accordance with the present invention may be used with other hardware configurations of the planar board. As one example, the system processor 54 could be an Intel Pentium processor, Cyrix 586-P75 processor or Advanced Micro Devices 8486 processor or any other suitable microprocessor.

FIG. 4 depicts a diagrammatic representation of a network packet which is sent by a personal computer 12 or computer 102 according to one embodiment. The network packet 400 comprises a network header 402 and data packet 404 that can be sent over a network, such as an Ethernet network. Network header 402 includes a MAC header 406, IP header 408, and UDP header 412 which are all known in the art to provide addresses, identifiers, and other information for assuring correct transfer of the packet 400. Data packet 404 includes the information content to be transferred.

The data packet 404 comprises a data type 420 which is first used to set up a category of data and a data portion 422, which provides specific information. The data type 420 indicates a transmission of system identification and capabilities. The data patterns defined are the (1) Universal Unique ID (UUID) which is used by computer 102 to reference personal computer 12, (2) serial number of personal computer 12 which is used by computer 102 to determine the model of personal computer 12, (3) IEEE Address which is assigned by IEEE to uniquely identify personal computer 12 on a network, and (4) Ethernet Vendor which identifies the vendor of the communication (Ethernet LAN) subsystem 94 in personal computer 12 used by the computer 102 to select the correct device driver. It should be understood that the data packet 404 and data patterns shown in FIG. 4 are by way of example only, and other packets and patterns can be used with the invention.

As one example of another packet, a type of data packet 404 called a “Magic Packet” is depicted in FIG. 5. In FIG. 5, data packet 404 comprises a Magic Packet frame 414 and command extensions 416. Magic Packet 414 comprises the source address (computer 102 MAC address), destination address (e.g., a remote client 104 MAC address or a multi-cast address for a broadcast Magic Packet), and a synchronization stream. The synchronization stream is typically six (6) bytes of FFh and is used to help client 104, particularly communication subsystem 94, recognize a frame as a Magic Packet frame 414. A delineator such as six bytes of FFh is easy for hardware to detect and identifies the information as a Magic Packet 414. In the embodiment depicted in FIG. 5, the content of Magic Packet 414 is a six bytes of “FF” followed by 16 copies of MAC addresses (with, for example, 8 copies of server MAC address and 8 copies of client MAC address) with no breaks or interruptions. In one alternative embodiment, there are 12 copies of MAC addresses, where 6 copies are client MAC addresses and 6 copies are server MAC addresses. The MAC addresses may be located anywhere within the data packet 404 but are preferably preceded by a synchronization stream. Remote client 104 will, in one embodiment, confirm that the Magic Packet 104 contains the proper (and proper number of) synchronization stream, server MAC address, and client MAC address before initiating the power on process.

In an alternative embodiment, a broadcast Magic Packet 414 may be used. In this embodiment, the Magic Packet 414 is intended to be received by all remote clients 104 on the network and the destination MAC address is listed as, for example, all ones (1's). This will indicate to remote client 104 that the Magic Packet 414 is intended for it, even though the client MAC address is not included. In another embodiment, a multicast broadcast to a specified group of remote clients 104 may be utilized.

Data packet 404 also may include command extensions 416. Computer 102 may specify one of a plurality of command extensions in data packet 404 in order to modify the network activity of remote client 104 in a particular way.

When a network packet 400 is received by client 104, it is received by physical layer and placed on the MII bus. When network packet 400 comprises a Magic Packet 414 (as shown in FIG. 5), the MAC detects that it includes Magic Packet 414, and then MAC ignores any command extensions 416.

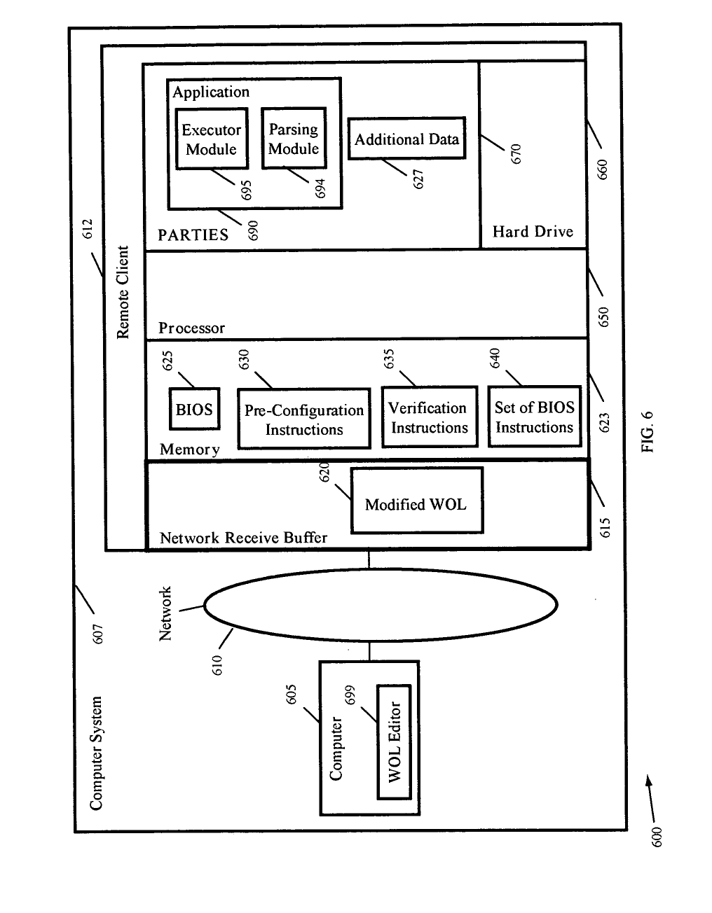

Turning now to FIG. 6, a system 600 for managing a remote client 612 of a computer system 607 is depicted. The system 600 includes a network 610 in commutation with the remote client 612 and a computer 605 operated by a system administrator or the like (“troubleshooter”), who intends to manage the remote client 612. In order to manage the remote client 612 of the computer system 607 in a pre-boot environment, that is, without the operating system associated with the computer system 607 loaded and running, the troubleshooter modifies an ordinary WOL packet through enabling software and/or hardware, such as a WOL editor 699, associated with the remote client 605. The WOL editor 699 permits the troubleshooter to add additional data, such as executable code, functions, script, drivers, and so forth to the payload portion of a WOL packet. As a result, the WOL editor 699 permits the troubleshooter to generate a modified WOL packet 620 for use in managing the remote client 612. For example, the modified WOL packet 620, may permit the remote client to not only “wake-up” the remote client, as is the function of an ordinary WOL packet, but the added additional data 627 of the modified WOL packet 620 may permit a resident application 690 on the remote client 612 to restore the system configuration, update software on the computer system 607, renew lease information for leased applications associated with the computer system 607, supplement or repair ROM scans performed by component parts such as the network receive buffer 615 of the computer system 607, and so on. In short, the additional data 690 in the modified WOL packet 620 may permit various and numerous types of management functions desired by the troubleshooter.

Before implementing the system 600, however, the troubleshooter or other empowered authority should provide the remote client 612 with pre-configuration instructions 630 for the remote client 612 to inform the BIOS 625 and network receive buffer 615 of the remote client 612 how to behave in response to the received, modified WOL packet 620. The pre-configuration instructions 630, enabled by software and/or hardware, direct the BIOS 625 and network receive buffer 615 of the remote client 612 to act in a certain, pre-scribed manner. In addition to the pre-configuration instructions 630, and also enabled by software and/or hardware associated with the remote client 612, the remote client 612 also includes verification instructions 635 to ensure that the integrity of the computer system 607 is not compromised by an unwanted intruder, i.e., hacker, or the like. An example of such verification instructions 635 include providing enabling logic for use of a public/private key algorithm utilized by the received, modified WOL packet 620 and the remote client 612 before storing the additional data 627 on the remote client 612. In this manner, ultimate use of the additional data 627 by a resident application 690 on the remote client 612 in managing the remote client 612 occurs without compromising the overall security of the computer system 607.

Through logic enabled by software and or hardware associated with the remote client 612, the system 600 further includes receiving of the modified WOL packet 620 by a network receive buffer 615 on a NIC or the like. The modified WOL packet 620 is transmitted over a network 610 from the computer 605, and once received, a set of BIOS instructions 640 provided to the remote client 612 instruct the BIOS how to behave in response to the received, modified WOL packet(s). In one example, the set of BIOS instructions 640, which reside in memory 623, such as flash memory, instruct the BIOS 625 to store the modified WOL packet 620 in memory 623 associated with the network receive buffer 615, to retrieve the modified WOL packet 620 from the network receive buffer 615, and after executing optional verification instructions 635, the set of BIOS instructions 640 further instruct the BIOS 625 to store the additional data 627 of the modified WOL packet 620 in the protection area run time interface extension services (“PARTIES”) space 670 of a hard drive 660 associated with the remote client 612. The PARTIES space 670, in layman's parlance, is a hidden area of the hard drive 660 that is not visible by the operating system (“OS”), which may or may not be operating during an implementation of the disclosed invention. If the OS is not operating, for whatever reason, then management of a remote client 612 or associated resource is still possible, and this is a key advantage of the invention. That is, managing, including performing diagnostics on a down remote client 612 or associated resources is possible without having a running OS, which may be malfunctioning partly or solely in relation to the remote client 612. If the OS is operating, then management of a remote client 612 or associated resource is also possible, but the added advantage of managing a remote client 612 without the OS is lost. It is understood, however, that this lost advantage in no way affects the scope or spirit of the disclosed and/or claimed invention.

Although FIG. 6 depicts the storing of the additional data 627 to the PARTIES space 670, the additional data 627 is depicted as being in PARTIES space 670 so that the additional data 627 is accessible by a resident application 690 also stored in the PARTIES space 670. That is, the additional data 627 may be stored in another location on or in association with the remote client 612 or computer system 607, but the location should be one that the resident application 690 on the PARTIES space 670 may access the additional data 627. After the set of BIOS instructions 640 further instructs the BIOS 625 to now boot to the PARTIES space 670, the resident application on the PARTIES space 670 utilizes the additional data 627, which is parsed by a parser module 694, and interpreted and executed by an executor module 695 enabled by logic associated with the application 690 or remote client 612 in order to perform the underlying function or purpose, i.e., management, associated with the additional data 627 found in the modified WOL packet(s) 620 that is received by the remote client 612.

In another example, the set of BIOS instructions 640, which reside in memory 623, such as flash memory, instruct the BIOS 625 to store the modified WOL packet 620 in memory 623 associated with the network receive buffer 615, to retrieve the modified WOL packet 620 from the network receive buffer 615, and after executing optional verification instructions 635, the set of BIOS instructions 640 further instruct the BIOS 625 to process the additional data 627, i.e., executable code. Such an example embodiment is ideally suited when the additional data 627 is a ROM BIOS extension added to the payload portion to form the modified WOL packet(s) 620. In such an example, the advantage over loading the payload to the PARTIES space 670 is that if for some reason the BIOS 625 cannot boot from a PARTIES space 670, then it is still possible for BIOS 625 to process the additional data 627, that is, for example, a ROM BIOS extension, received in the memory 623 of the remote client 612.

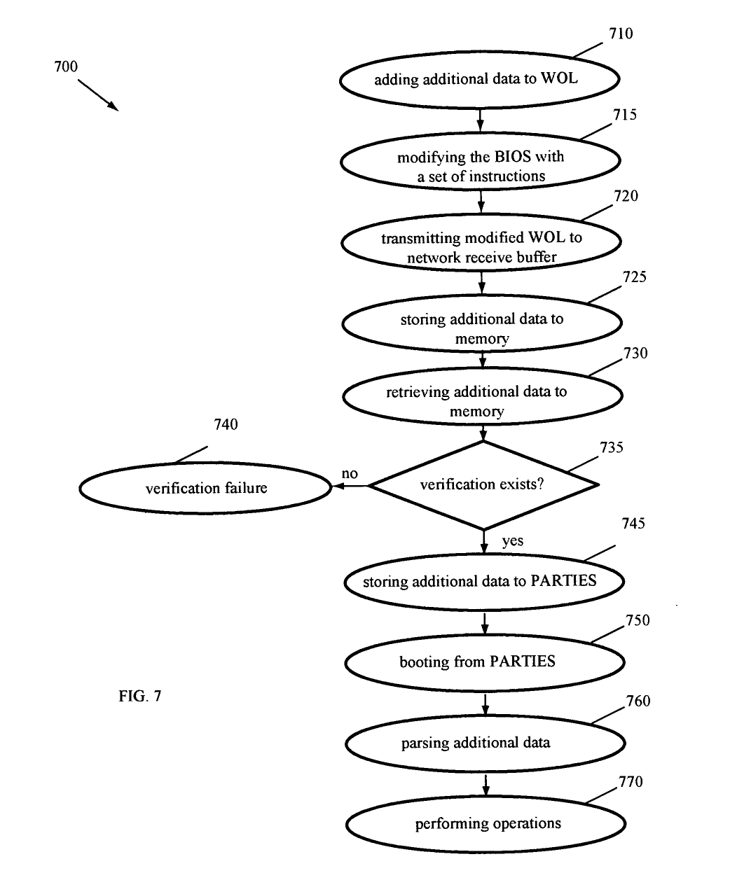

Turning now to FIG. 7, another aspect of the invention is disclosed. In particular, an embodiment of a flowchart 700 for managing a remote client of a computer system is disclosed. Flowchart 700 is for a system, such as system 600, as shown in FIG. 6.

Flowchart 700 begins by adding 710 additional data to an ordinary WOL packet, such as AMD's Magic Packet. By a system operator or other empowered authority (“troubleshooter”) adding 710 additional data to an ordinary WOL packet, the troubleshooter is modifying, made possible by enabling software and/or hardware, such as a WOL editor associated with the troubleshooter's computer, server, workstation, or the like, an ordinary WOL packet. The adding 710 of the additional data, such as executable code, functions, script, drivers, patches, fixes, and so forth to the payload portion of a WOL packet, the troubleshooter preparing a modified WOL packet for transmitting 715 to the remote client needing to or desired to be managed by the troubleshooter. As previously discussed, adding 710 the additional data to form the modified WOL packet 620, may permit the remote client to not only “wake-up” the remote client, as is the function of an ordinary WOL packet, but the added additional data of the modified WOL packet may permit a resident application on the remote client to restore the system configuration, update software on the computer system, renew lease information for leased applications associated with the computer system, perform diagnostics, supplement or repair ROM scans performed by component parts such as the network receive buffer of the computer system, and so on. These are but a few examples of how adding 710 additional data for ultimate management of the remote client is possible, but it is to be understood that what additional data is added is potentially limitless and dependent only on the imagination of the troubleshooter and the available resources associated with the remote client to be managed.

The flowchart 700 continues by modifying 715 the BIOS with a set of instructions, wherein the BIOS is associated with the remote client and likely located in the remote client's flash memory. In modifying 715 the BIOS with a set of instructions, enabled by software and/or hardware associated with the computer system having the remote client, the troubleshooter or other empowered authority provides the remote client with the set of instructions for directing the BIOS, network receive buffer, and other component parts on how to behave in response to received, modified WOL packet(s) that are to be transmitted 720 to the remote client.

Moving down the flowchart 700, transmitting 720 of the modified WOL packet(s) from the troubleshooter's computer to the remote client occurs over a network in communication with the computer and remote client. In one example embodiment, the transmitting 720 of the modified WOL packet(s) culminates in a network receive buffer of the remote client receiving the modified WOL packet(s). Once received, the set of instructions, in one embodiment, direct the BIOS to store 725 the additional data, i.e., executable code, in memory, such as flash memory, associated with the network receive buffer, and then to retrieve 730 the additional data, i.e., executable code, from the memory associated with the network receive buffer, for example, that memory and buffer found on a NIC.

Before using the additional data found in the received, modified WOL packet(s), however, the flowchart 700 depicts a verifying decision block 735 for the verification instructions optionally provided for use by the remote client. If verification instructions exist, then the verification instructions, enabled by software and/or hardware, exist for execution by the client resource, queries the integrity of the received, modified WOL packet(s) to ensure that the security of the computer system 607 is not compromised by an unauthorized actions on the remote client, its resources, or the computer system as a whole. An example of such verification instructions include providing enabling logic for use of a public/private key algorithm utilized by the received, modified WOL packet and the remote client. If the executed verification instructions indicate that the modified WOL packets and/or the troubleshooter has authority to perform the particular management actions underlying the additional data, then the troubleshooter may continue down the flowchart 700 continues. However, if verification instructions render a failure 740 for whatever reason, such as due to timing out or unauthorized, modified WOL packet(s), then the flowchart 700 culminates without further processing of the modified WOL packet(s) received by the network receive buffer.

Presuming verification exists or the optional, verification instructions are not implemented, then the flowchart 700 continues by further implementation of the provided set of instructions that direct the BIOS to store 745 the additional data of the modified WOL packet in the protection area run time interface extension services (“PARTIES”) space of a hard drive associated with the remote client, wherein PARTIES is a hidden area from the OS and often contains vendor applications that can be used with or without the OS up and running. Once stored, the provided set of instructions further direct BIOS to boot 750 to the PARTIES, wherein further logic associated with an application stored on PARTIES accesses the additional data stored on PARTIES. The flowchart 700 continues by the application parsing 760 the additional data, and after the application interprets the parsed additional data, the application executes the application now having the additional data in order for performing 770 the operations underlying the purpose of the additional data in the modified WOL packet(s) sent for managing the remote client.

In another embodiment, and with reference to flowchart 700, after moving down the flowchart 700 from the top to the point of optionally determining whether verification exists 735, the flowchart 700 may move directly to performing 770 operations as shown on the flowchart 700 if the above-discussed, optional verification exists 735. That is, in such an embodiment, the storing 745, booting 750, and parsing 760 of the additional data by an application do not occur. Instead, performing 770 the operations enabled by the retrieved, and optionally verified additional data, such as executable code, occurs by the BIOS. Such an example embodiment is ideally suited when the additional data is a ROM BIOS extension added to the payload portion to form the modified WOL packet(s). In such an example, the advantage over loading the payload to the PARTIES space is that if for some reason the BIOS cannot boot from a PARTIES space, then it is still possible for BIOS to process the additional data, that is, for example, a ROM BIOS extension, received in the memory of the remote client.

One embodiment of the invention is implemented as a program product for use with a computer system such as, for example, the system 101 shown in FIG. 1. The program product could be used on a computer 102, on a remote client 104, or any combination thereof, or on other computer systems or processors. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for managing one or more client computer systems, where one or more clients may be asleep. It is understood that the form of the invention shown and described in the detailed description and the drawings are to be taken merely as examples. It is intended that the following claims be interpreted broadly to embrace all the variations of the example embodiments disclosed.

1. A method comprising:
receiving, at a client of a computer system a modified wake-on-LAN packet via a network receive buffer on the client, the modified wake-on-LAN packet comprising executable code;
storing the executable code in memory associated with the network receive buffer;
retrieving the executable code from the memory by an action of BIOS associated with the client; and
processing the executable code using the BIOS.

2. The method of claim 1, further comprising:
adding the executable code to a wake-on-LAN packet to yield the modified wake-on-LAN packet and
transmitting the modified wake-on-LAN packet to the client.

3. The method of claim 1, further comprising verifying the modified wake-on-LAN packet using the BIOS.

4. The method of claim 1, further comprising storing the retrieved executable code to a PARTIES partition of a hard drive associated with the client.

5. The method of claim 4, further comprising booting the client from the PARTIES partition using the BIOS prior to the processing of the executable code, wherein the processing occurs through use of an application stored on the PARTIES partition.

6. The method of claim 1, further comprising modifying the BIOS with a set of instructions for the method prior to receiving the modified wake-on-LAN packet.

7. The method of claim 1, wherein the processing of the executable code comprises processing a ROM BIOS extension.

8. The method of claim 1, wherein the receiving comprises receiving the modified wake-on-LAN packet over a network.

9. A service comprising:
adding executable code to a wake-on-LAN packet to yield a modified wake-on-LAN packet, the executable code being designed for storage in a network receive buffer of a remote client of a computer system and for processing by BIOS associated with the client; and
transmitting the modified wake-on-LAN packet to the client via a network in communication with the client.

10. The service of claim 9, further comprising:
receiving the modified wake-on-LAN packet via the network receive buffer on the remote client;
storing the executable code in memory associated with the network receive buffer;
retrieving the executable code from the memory by an action of BIOS associated with the client; and
processing the executable code using the BIOS.

11. The service of claim 9, further comprising modifying the BIOS with a set of instructions for the service prior to transmitting the modified wake-on-LAN packet.

12. A system comprising:
a network which establishes communication between a client and a server computer of a computer system;
a network receive buffer at the client which receives a modified wake-on-LAN packet, the modified wake-on-LAN packet comprising executable code;
memory coupled to a processor of the client;
code stored in the memory which comprises a first instruction directing BIOS associated with the client to store the executable code in the memory, a second instruction directing retrieval of the executable code from the memory, and a third instruction directing processing of the executable code.

13. The system of claim 12, further comprising a wake-on-LAN packet editor for adding the executable code to a wake-on-LAN packet to yield the modified wake-on-LAN packet.

14. The system of claim 12, wherein the memory further comprises BIOS instructions for verifying integrity of the modified wake-on-LAN packet.

15. The system of claim 12, wherein the system further comprises pre-configuring instructions for the BIOS and the network receive buffer.

16. The system of claim 12, wherein the memory further comprises BIOS instructions for storing the executable code to a PARTIES partition of a hard drive associated with the client to enable booting by the BIOS from the PARTIES partition.

17. The system of claim 16, wherein the third instruction occurs through use of an application stored on the PARTIES partition.

18. The system of claim 12, wherein the executable code comprises a ROM BIOS extension.

19. The system of claim 12, wherein the network receive buffer comprises the network receive buffer on a NIC card having wake-on-LAN support capability.

20. An apparatus comprising:
a computer readable medium;
code stored on said medium which is effective, when executed on a computer system, to cause the apparatus to perform operations, by:
modifying a wake-on-LAN packet to add executable code thereto; and
transmitting the modified wake-on-LAN packet over a communications network to a client associated with the computer system; and
the executable code enabling service access to the client when received, stored, retrieved and processed by the client.

21. The apparatus of claim 20, further comprising a set of instructions stored on the medium prior to transmitting the modified wake-on-LAN packet code, wherein the set, when executed, is effective to cause the apparatus to modify the BIOS of a client.

22. The apparatus of claim 21, wherein the code for transmitting comprises instructions for transmitting over a network from a computer of the computer system to the remote client.

23. An apparatus comprising:
a computer readable medium;
code stored on said medium which is effective, when executed by a client of a computer system, to perform operations of:
receiving in network receive buffer of the client a modified wake-on-LAN packet via a communications network from a computer system associated with the client, wherein the modified wake-on-LAN comprises executable code;
storing the executable code in memory associated with a network receive buffer;
retrieving the executable code from the memory by an action of BIOS associated with the client; and
processing the executable code using the BIOS; and the executable code enabling service to the client by performing the code.

24. The apparatus of claim 23, wherein the code further comprises instructions stored on the medium for verifying the modified wake-on-LAN packet using the BIOS.

25. The apparatus of claim 23, wherein the code for the storing comprises instructions stored on the medium for storing the executable code to a PARTIES partition of a hard drive associated with the client.

26. The apparatus of claim 25, further comprising additional code stored on the medium for booting the client from the PARTIES partition using the BIOS prior to the processing of the executable code, wherein the processing occurs through use of an application stored on the PARTIES partition.

27. The apparatus of claim 25, wherein the code for processing comprises instructions for a ROM BIOS extension.

28. A machine-accessible medium containing instructions, which when executed by a machine, cause the machine to perform operations for managing a remote client of a computer system, comprising:
receiving, at a client of a computer system a modified wake-on-LAN packet via a network receive buffer on the client, the modified wake-on-LAN packet comprising executable code;
storing the executable code in memory associated with the network receive buffer;
retrieving the executable code from the memory by an action of BIOS associated with the client; and
processing the executable code using the BIOS.

29. The machine-accessible medium of claim 28, wherein the instructions further comprise operations for
adding the executable code to a wake-on-LAN packet to yield the modified wake-on-LAN packet and
transmitting the modified wake-on-LAN packet to the client.

30. The machine-accessible medium of claim 29, wherein the instructions further comprise operations for modifying the BIOS with a set of instructions prior to performing the instructions for transmitting.

31. The machine-accessible medium of claim 28, wherein the instructions further comprise operations for verifying the modified wake-on-LAN packet using the BIOS.

32. The machine-accessible medium of claim 28, wherein the instructions further comprise operations for storing, after performing the instructions for retrieving, of the executable code to a PARTIES partition of a hard drive associated with the remote client.

33. The machine-accessible medium of claim 32, wherein the instructions further comprise operations for booting, by the BIOS, from the PARTIES partition prior to performing the instructions for processing of the executable code, wherein the instructions for processing occur through use of an application stored on the PARTIES partition.

34. The machine-accessible medium of claim 28, wherein the instructions for processing of the executable code comprise instructions for processing a ROM BIOS extension.

35. The machine-accessible medium of claim 28, wherein the receiving comprises receiving the modified wake-on-LAN packet over a network.
